(19) United States
(12) Patent Application Publication
(10) Pub. No.: US 2019/0094806 A1
(43) Pub. Date: Mar. 28, 2019

(54) WHEEL TRAIN DEVICE AND TIMEPIECE

(71) Applicant: CASIO COMPUTER CO., LTD., Tokyo (JP)

(72) Inventors: Ryoichi KUNIMI, Tokyo (JP); Yoshihiko ENTA, Saitama-shi (JP)

(73) Assignee: CASIO COMPUTER CO., LTD., Tokyo (JP)

(21) Appl. No.: 16/142,062

(22) Filed: Sep. 26, 2018

(30) Foreign Application Priority Data
Sep. 27, 2017 (JP) 2017-185877

(51) Int. Cl. G04B 19/02

(52) U.S. Cl. CPC G04B 19/02; G04B 19/241

(57) ABSTRACT

A wheel train device including a dial plate having a display area provided between a central portion and an outer peripheral portion, a wheel train section having a pointer wheel to which a pointer that moves above the display area is attached, a supporting member which supports the wheel train section in an area corresponding to the display area, and a plurality of shaft attachment holes which are provided in a plurality of positions of the supporting member and to which the pointer wheel is selectively attached in one of the plurality of positions.

### CROSS-REFERENCE TO RELATED APPLICATION

This application is based upon and claims the benefit of priority from the prior Japanese Patent Application No. 2017-185877, filed Sep. 27, 2017, the entire contents of which are incorporated herein by reference.

### BACKGROUND OF THE INVENTION

### 1. Field of the Invention

The present invention relates to a wheel train device used for a timepiece such as a wristwatch and a timepiece including the same.

### 2. Description of the Related Art

For example, a wristwatch is known which includes a wheel train section which transmits rotation of a motor to a pointer wheel using a plurality of intermediate wheels and is structured to move a pointer attached to a pointer shaft of the pointer wheel in the wheel train section, as described in Japanese Patent Application Laid-Open (Kokai) Publication No. 2001-324579.

The wheel train section in this wristwatch is structured such that the plurality of intermediate wheels and the pointer wheel are rotatably supported by at least two upper and lower supporting members. That is, each of the two supporting members is provided with a plurality of shaft attachment holes for respectively supporting the top and bottom of shaft sections of the plurality of intermediate wheels and the top and bottom of the pointer shaft of the pointer wheel to correspond to each other.

In this wristwatch, when the installation position of the pointer is changed, the installation position of the pointer wheel needs to be changed. Correspondingly, the position of the shaft attachment hole in the supporting member must be changed. Accordingly, the supporting member must be newly manufactured and replaced.

### SUMMARY OF THE INVENTION

An object of the present invention is to provide a wheel train device by which a supporting member is not required to be replaced and the installation position of a pointer can be easily changed, and a timepiece including the same.

In accordance with an aspect of the present invention, there is provided a wheel train device comprising: a dial plate having a display area provided between a central portion and an outer peripheral portion; a wheel train section having a pointer wheel to which a pointer that moves above the display area is attached; a supporting member which supports the wheel train section in an area corresponding to the display area; and a plurality of shaft attachment holes which are provided in a plurality of positions of the supporting member and to which the pointer wheel is selectively attached in one of the plurality of positions.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is an enlarged front view showing a first embodiment;

FIG. 2 is an enlarged front view showing a timepiece module incorporated into a wristwatch shown in FIG. 1.

FIG. 3 is an enlarged rearview of the main portion showing a wheel train state in a third sub-display area shown in FIG. 2;

FIG. 4 is an enlarged sectional view showing the main portion of the timepiece module taken along line A-A in FIG. 3;

FIG. 5 is an enlarged rear view of the main portion showing a supporting member in the third sub-display area shown in FIG. 3;

FIG. 6 is an enlarged front view showing a state where the installation position of a third sub-pointer has been changed in a different third sub-display area in the timepiece module shown in FIG. 2;

FIG. 7 is an enlarged rear view of the main portion showing a wheel train state in the third sub-display area shown in FIG. 6;

FIG. 8 is an enlarged front view showing a timepiece module in a second embodiment; and

FIG. 9 is an enlarged rearview of the main portion showing an example of a wheel train state in a third sub-display area shown in FIG. 8.

### DETAILED DESCRIPTION OF THE PREFERRED EMBODIMENTS

### First Embodiment

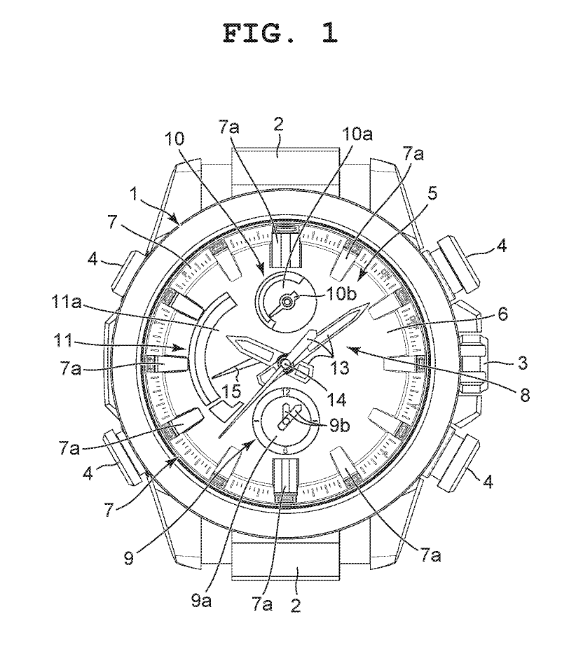

A first embodiment will be described below with reference to FIG. 1 to FIG. 7.

This wristwatch includes a wristwatch case 1, as shown in FIG. 1. In side portions of the wristwatch case 1 on the six o'clock side and the twelve o'clock side, band attaching sections 2 are respectively provided.

In a side portion of the wristwatch case 1 on the 3 o'clock side, a switch operation section 3 such as a crown is provided, as shown in FIG. 1. In side portions of the wristwatch case 1 on the 2 o'clock side, the 4 o'clock side, the 8 o'clock side and the 10 o'clock side, push-button switches 4 are respectively provided. Inside the wristwatch case 1, a timepiece module 5 is provided.

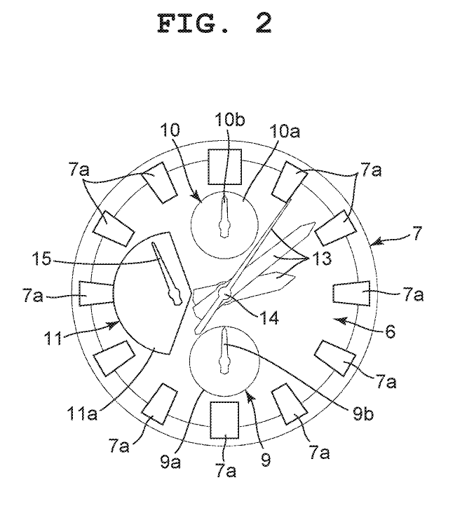

This timepiece module 5 includes a substantially disk-shaped dial plate 6 arranged on its upper surface and a ring-shaped parting member 7 arranged in an outer peripheral portion on the upper surface of the dial plate 6, as shown in FIG. 1 and FIG. 2. On the upper surface of the parting member 7, a plurality of hour marks 7a are provided at equal intervals along a circumferential direction.

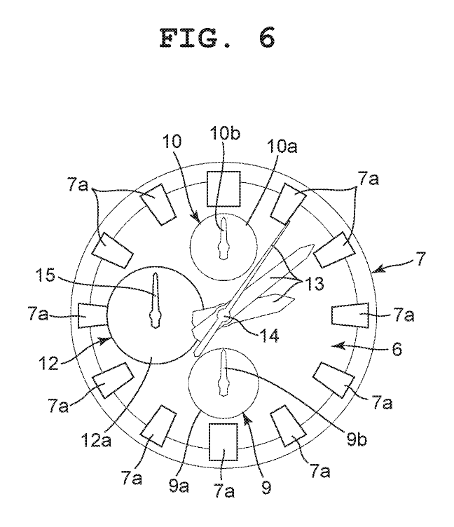

This timepiece module 5 also includes a main display section 8 (a main display area) which indicates the current time, a first sub-display section 9 which indicates the world time, a second sub-display section 10 which indicates a day of the week, and two types of third sub-display sections 11 and 12 which indicate a stop watch function and a remaining amount of a battery, as shown in FIG. 1, FIG. 2 and FIG. 6.

The main display section 8, which indicates the current time, includes pointers 13 such as a second hand, a minute hand, and an hour hand which is provided in a central portion of the dial plate 6 and moves above the dial plate 6, and a pointer shaft 14 which protrudes upward in the central portion of the dial plate 6 and to which each of the pointers 13 is attached, as shown in FIG. 1 and FIG. 2. By this structure, each of the pointers 13 moves above the dial plate 6 as the pointer shaft 14 rotates, and indicates an hour mark 7a on the parting member 7 in the main display section 8, whereby the current time is indicated.

The first sub-display section 9 is a section which indicates the time of one of the cities in the world, as shown in FIG. 1 and FIG. 2. This first sub-display section 9 includes a substantially circular-shaped first sub-display area 9a provided between the central portion of the dial plate 6 and an outer peripheral portion of the dial plate 6 on the 6 o'clock side and a first sub-pointer 9b which moves in an upper portion of the first sub-display area 9a. By this structure, the first sub-pointer 9b moves in the upper portion of the first sub-display area 9a in the first sub-display section 9, whereby the time of the selected city is indicated.

The second sub-display section 10, which is a section which indicates a day of the week, includes a substantially circular-shaped second sub-display area 10a provided between the central portion of the dial plate 6 and an outer peripheral portion of the dial plate 6 on the 12 o'clock side and a second sub-pointer 10b which moves in an upper portion of the second sub-display area 10a, as shown in FIG. 1 and FIG. 2. By this structure, the second sub-pointer 10b moves in the upper portion of the second sub-display area 10a in the second sub-display section 10, whereby the day of the week is selectively indicated.

One of the two types of third sub-display sections 11 and 12, that is, the third sub-display section 11 is a section which indicates a stop watch time, and includes a substantially fan-shaped third sub-display area 11a provided between the central portion of the dial plate 6 and an outer peripheral portion of the dial plate 6 on the 9 o'clock side and a third sub-pointer 15 which moves in an upper portion of the third sub-display area 11a, as shown in FIG. 1 and FIG. 2. By this structure, the stop watch time is indicated by the third sub-pointer 15 moving back and forth by a retrograde mechanism in the upper portion of the third sub-display area 11a for each 1/20 second in the third sub-display section 11.

The other third sub-display section 12 of the two types of third sub-display sections 11 and 12 is a section which indicates the remaining amount of the battery, and includes a substantially circular-shaped third sub-display area 12a provided between the central portion of the dial plate 6 and the outer peripheral portion of the dial plate 6 on the 9 o'clock side and a third sub-pointer 15 which moves in an upper portion of the third sub-display area 12a, as shown in FIG. 6. By this structure, the third sub-pointer 15 moves in the upper portion of the third sub-display area 12a in the other third sub-display section 12, whereby the remaining amount of the battery is indicated.

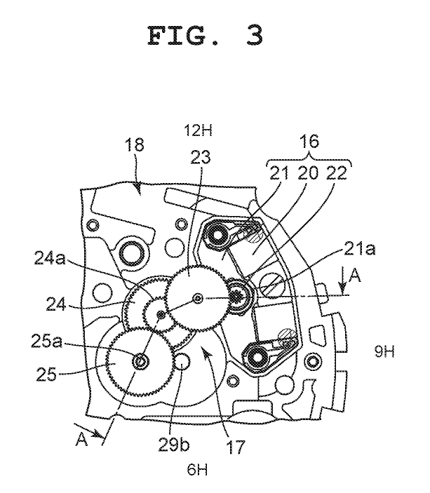

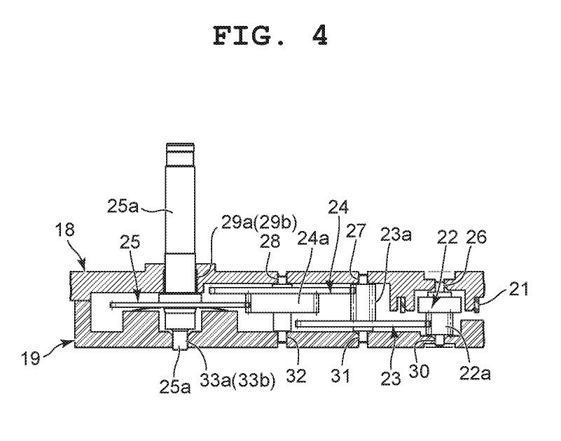

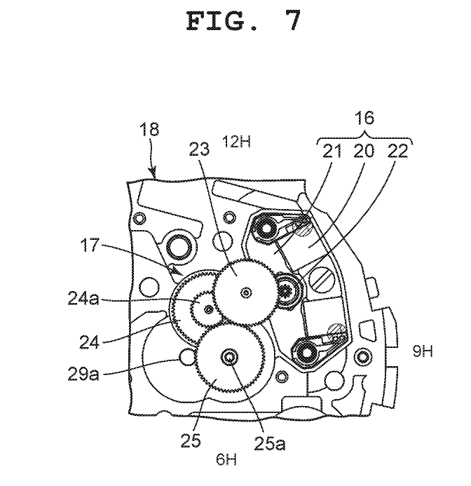

Each of the two types of third sub-display sections 11 and 12 includes a stepping motor 16 and a wheel train section 17, as shown in FIG. 3, FIG. 4 and FIG. 7, and the stepping motor 16 and the wheel train section 17 are attached between the first supporting member 18 and the second supporting member 19. The stepping motor 16 includes a coil section 20, a stator 21 which introduces a magnetic field intermittently generated in the coil section 20, and a rotor 22 which is arranged in a stator hole 21a provided in a central portion of the stator 21 and intermittently rotates in accordance with the magnetic field intermittently generated in the coil section 20.

The wheel train section 17 includes a first intermediate wheel 23 which rotates as the rotor 22 in the stepping motor 16 rotates, a second intermediate wheel 24 which rotates as the first intermediate wheel 23 rotates, and a sub-pointer wheel 25 which rotates as the second intermediate wheel 24 rotates, and is structured such that the third sub-pointer 15 is attached to a sub-pointer shaft 25a in the sub-pointer wheel 25, as shown in FIG. 3 and FIG. 4.

That is, the first intermediate wheel 23 rotates while engaging with a rotor pinion 22a in the rotor 22 in the stepping motor 16, as shown in FIG. 3 and FIG. 4. The second intermediate wheel 24 rotates while engaging with a first pinion 23a in the first intermediate wheel 23. The sub-pointer wheel 25 rotates while engaging with a second pinion 24a in the second intermediate wheel 24.

The first and second supporting members 18 and 19 are respectively provided corresponding to third sub-display areas 11a and 12a in the two types of third sub-display sections 11 and 12 positioned between the central portion of the dial plate 6 and the outer peripheral portion of the dial plate 6 on the 9 o'clock side, as shown in FIG. 2 to FIG. 5. The first supporting member 18 is provided with a shaft attachment hole 26 which supports the top of a rotor shaft of the rotor 22, a shaft attachment hold 27 which supports the top of a first shaft of the first intermediate wheel 23, a shaft attachment hole 28 which supports the top of a second shaft of the second intermediate wheel 24, and two types of first and second shaft attachment holes 29a and 29b which support the sub-pointer shaft 25a in the sub-pointer wheel 25.

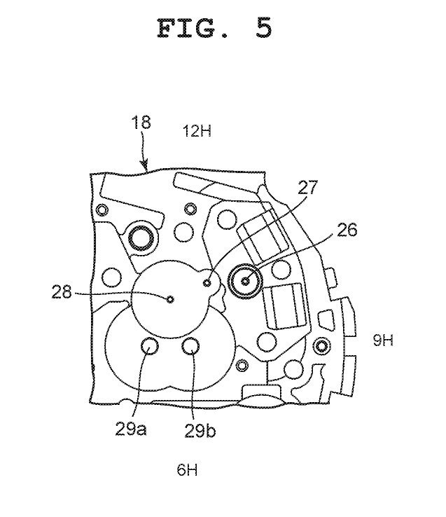

The two types of first and second shaft attachment holes 29a and 29b are respectively holes into which the sub-pointer shaft 25a in the sub-pointer wheel 25 which protrudes upward from the first supporting member 18 is selectively inserted, and are provided in the first supporting member 18 such that the sub-pointer shaft 25a in the sub-pointer wheel 25 is selectively attached to one of the first and second shaft attachment holes 29a and 29b, as shown in FIG. 3 to FIG. 7. That is, the first and second shaft attachment holes 29a and 29b are provided on a circumference centered at the rotation center of the second intermediate wheel 24 which engages with the sub-pointer wheel 25, as shown in FIG. 5.

As a result, the sub-pointer wheel 25 is structured such that the sub-pointer shaft 25a is inserted into the first shaft attachment hole 29a as shown in FIG. 4, and is arranged in an area central to a substantially fan shape of the third sub-display area 11a in the third sub-display section 11 of the two types of third sub-display sections 11 and 12, i.e., a position close to the pointer shaft 14 in the main display section 8 so as to move the third sub-pointer 15 back and forth in the upper portion of the third sub-display area 11a with the third sub-pointer 15 being attached to the sub-pointer shaft 25a, as shown in FIG. 2.

This sub-pointer wheel 25 is also structured such that the sub-pointer shaft 25a is inserted into the second shaft attachment hole 29b as shown in FIG. 7, and is arranged in a substantially circular-shaped central portion of the third sub-display area 12a in the other third sub-display section 12 of the two types of third sub-display sections 11 and 12, i.e., a position away from the pointer shaft 14 in the main display section 8 so as to move the third sub-pointer 15 in the upper portion of the third sub-display area 12a with the third sub-pointer 15 being attached to the sub-pointer shaft 25a.

On the other hand, as shown in FIG. 4, the second supporting member 19 is provided with a shaft attachment hole 30 which supports the bottom of a rotor shaft of the rotor 22, a shaft attachment hole 31 which supports the bottom of a first shaft of the first intermediate wheel 23, a shaft attachment hole 32 which supports the bottom of a second shaft of the second intermediate wheel 24, and two types of first and second shaft attachment holes 33a and 33b which support the bottom of the sub-pointer shaft 25a in the sub-pointer wheel 25, as in the case of the first supporting member 18.

The two types of first and second shaft attachment holes 33a and 33b are also holes into which the sub-pointer shaft 25a in the sub-pointer wheel 25 is selectively inserted, and are provided in the second supporting member 19 such that the sub-pointer shaft 25a in the sub-pointer wheel 25 is selectively attached to one of the first and second shaft attachment holes 33a and 33b, as shown in FIG. 3 to FIG. 7. The first and second shaft attachment holes 33a and 33b are provided on the circumference centered at the rotation center of the second intermediate wheel 24 which engages with the sub-pointer wheel 25, as with the first and second shaft attachment holes 29a and 29b in the first supporting member 18.

Next, the mechanism of this wristwatch is described.

In this wristwatch, one of the two types of third sub-display sections 11 and 12 can be selectively provided. In the case where the third sub-display section 11 is selected, for example, the stepping motor 16 and the wheel train section 17 are first arranged in the first supporting member 18 with the first supporting member 18 being turned over, as shown in FIG. 3.

Here, the top of the rotor shaft of the rotor 22 in the stepping motor 16 is inserted into and supported on the shaft attachment hole 26 in the first supporting member 18. The top of the first shaft of the first intermediate wheel 23 in the wheel train section 17 is inserted into the shaft attachment hole 27 in the first supporting member 18, so that the first intermediate wheel 23 engages with the rotor pinion 22a in the rotor 22. The top of the second shaft of the second intermediate wheel 24 in the wheel train section 17 is inserted into the shaft attachment hole 28 in the first supporting member 18, so that the second intermediate wheel 24 engages with the first pinion 23a in the first intermediate wheel 23.

In this state, the sub-pointer wheel 25 is arranged in the first supporting member 18. Here, the sub-pointer shaft 25a in the sub-pointer wheel 25 is inserted into, of the two types of first and second attachment holes 29a and 29b in the first supporting member 18, the first shaft attachment hole 29a located close to the central portion of the dial plate 6, so that the sub-pointer wheel 25 engages with the second pinion 24a in the second intermediate wheel 24. As a result, the sub-pointer wheel 25 is arranged in the first supporting member 18 with the sub-pointer shaft 25a protruding upward from the first supporting member 18.

Then, the second supporting member 19 is arranged corresponding to the first supporting member 18. Here, the bottom of the rotor shaft of the rotor 22 in the stepping motor 16 is inserted into and supported on the shaft attachment hole 30 in the second supporting member 19. The bottom of the first shaft of the first intermediate wheel 23 is inserted into and supported on the shaft attachment hole 31 in the second supporting member 19. The bottom of the second shaft of the second intermediate wheel 24 is inserted into and supported on the shaft attachment hole 32 in the second supporting member 19.

Further, the bottom of the sub-pointer shaft 25a in the sub-pointer wheel 25 is inserted into and supported on, of the two types of first and second shaft attachment holes 33a and 33b in the second supporting member 19, the first shaft attachment hole 33a corresponding to the first shaft attachment hole 29a in the first supporting member 18. As a result, the stepping motor 16 and the wheel train section 17 are assembled between the first supporting member 18 and the second supporting member 19.

In this case, the sub-pointer shaft 25a in the sub-pointer wheel 25 is arranged at a position central to a substantially fan shape of the third sub-display area 11a in the third sub-display section 11. In this state, the third sub-pointer 15 is attached to the sub-pointer shaft 25a in the sub-pointer wheel 25 which protrudes upward from the first supporting member 18. As a result, the third sub-display section 11 has a display form where the third sub-pointer 15 moves in the upper portion of the substantially fan-shaped third sub-display area 11a, as shown in FIG. 1 and FIG. 2.

On the other hand, in the case where the other third sub-display section 12 of the two types of third sub-display sections 11 and 12, which is shown in FIG. 6, is selected, the stepping motor 16, the first intermediate wheel 23, and the second intermediate wheel 24 are arranged in the first supporting member 18 as shown in FIG. 7, as in the case where the above-described third sub-display section 11 is selected.

The sub-pointer shaft 25a in the sub-pointer wheel 25 is inserted into, of the two types of first and second attachment holes 29a and 29b in the first supporting member 18, the second shaft attachment hole 29b located far from the central portion of the dial plate 6, so that the sub-pointer wheel 25 engages with the second pinion 24a in the second intermediate wheel 24. As a result, the sub-pointer wheel 25 is arranged in the first supporting member 18 with the sub-pointer shaft 25a protruding upward from the first supporting member 18.

In this state, the second supporting member 19 is arranged corresponding to the first supporting member 18 so as to support the rotor 22, the first intermediate wheel 23, and the second intermediate wheel 24 in the stepping motor 16. Here, the bottom of the sub-pointer shaft 25a in the sub-pointer wheel 25 is inserted into and supported on, of the two types of first and second shaft attachment holes 33a and 33b in the second supporting member 19, the second shaft attachment hole 33b corresponding to the second shaft attachment hole 29b in the first supporting member 18.

As a result, the stepping motor 16 and the wheel train section 17 are assembled between the first supporting member 18 and the second supporting member 19. Here, the sub-pointer shaft 25a in the sub-pointer wheel 25 is arranged in the substantially circular-shaped central portion of the third sub-display area 12a in the other third sub-display section 12. In this state, the third sub-pointer 15 is attached to the sub-pointer shaft 25a in the sub-pointer wheel 25 which protrudes upward from the first supporting member 18. As a result, the third sub-display section 12 has a display form where the third sub-pointer 15 moves in the upper portion of the substantially circular-shaped third sub-display area 12a, as shown in FIG. 6.

Next, the use of the wristwatch is described.

In a normal state, the pointer shaft 14 in the main display section 8 rotates to move the pointers 13 such as the second hand, the minute hand and the hour hand above the dial plate 6, and the pointer 13 indicates an hour mark 7a on the parting member 7 arranged in the outer peripheral portion of the dial plate 6, whereby the current time can be known.

Also, here, the first sub-pointer 9b in the first sub-display section 9 moves in the upper portion of the first sub-display area 9a so as to indicate an hour mark (not shown) of the first sub-display area 9a, whereby the time of one of the cities in the world can be known. Similarly, in the second sub-display section 10, the second sub-pointer 10b moves in the upper portion of the second sub-display area 10a so as to indicate a day of the week in the second sub-display area 10a, whereby the day of the week can be known.

Also, here, when the third sub-display section 11 has been selected from the two types of third sub-display sections 11 and 12, an indicator of the third sub-display area 11a is indicated by the third sub-pointer 15 in the third sub-display section 11 moving back and forth by a retrograde mechanism for each 1/20 second in the upper portion of the substantially fan-shaped third sub-display area 11a, whereby a stop watch time can be known.

On the other hand, when the other one third sub-display section 11 has been selected from the two types of third sub-display sections 11 and 12, the third sub-pointer 15 in the third sub-display area 12 moves in the upper portion of the substantially circular-shaped third sub-display area 12a so as to indicate an indicator of the third sub-display area 12a, whereby the remaining amount of the battery can be known.

As described above, this wristwatch includes the dial plate 6 in which one of the two types of third sub-display areas 11a and 12a is provided between the central portion and the outer peripheral portion on the 9 o'clock side, the wheel train section 17 including the sub-pointer wheel 25 to which the third sub-pointer 15 that moves above the third sub-display areas 11a and 12a is attached, the first and second supporting members 18 and 19 which respectively support the wheel train section 17 in areas corresponding to the third sub-display areas 11a and 12a, and the first and second shaft attachment holes 29a and 29b and the first and second shaft attachment holes 33a and 33b which are provided in plural areas of the first and second supporting members 18 and 19 and to which the sub-pointer wheel 25 is selectively attached. As a result, the first and second supporting members 18 and 19 need not be replaced, and the installation position of the third sub-pointer 15 can be easily changed.

That is, in this wristwatch, the first and second shaft attachment holes 29a and 29b provided in the plurality of positions of the first supporting member 18 and the first and second shaft attachment holes 33a and 33b provided in the plurality of positions of the second supporting member 19 respectively correspond to each other, and the sub-pointer wheel 25 in the wheel train section 17 can be selectively attached to either one of the two sets of shaft attachment holes. Accordingly, the first and second supporting members 18 and 19 need not be replaced, and the installation position of the sub-pointer shaft 25a in the sub-pointer wheel 25 can be changed, whereby the installation position of the third sub-pointer 15 can be easily changed.

Also, in this wristwatch, the wheel train section 17 includes the first and second intermediate wheels 23 and 24 which transmit the rotation of the stepping motor 16 to the sub-pointer wheel 25, and the first and second shaft attachment holes 29a and 29b and the first and second shaft attachment holes 33a and 33b are provided on the circumference centered at the rotation center of the second intermediate wheel 24 which engages with the sub-shaft wheel 25. As a result, even when the sub-pointer shaft 25a in the sub-pointer wheel 25 is attached to either the first shaft attachment holes 29a and 33a or the second shaft attachment holes 29b and 33b, the sub-pointer wheel 25 can be reliably and favorably rotated by the second intermediate wheel 24.

Also, in this wristwatch, the two types of third sub-display sections 11 and 12 are respectively provided in different dial plates 6, and the third sub-display sections 11 and 12 respectively include the two different third sub-display areas 11a and 12a. By the third sub-pointer 15 being moved within the third sub-display area 11a of the two third sub-display areas 11a and 12a, a stop watch time can be known. By the third sub-pointer 15 being moved within the other third sub-display area 12a, the remaining amount of the battery can be known.

That is, the two types of third sub-display areas 11a and 12a differ in display form based on whether the sub-pointer wheel 25 is attached to the first shaft attachment holes 29a and 33a or attached to the second shaft attachment holes 29b and 33b. As a result, the different two types of functions and the display shapes respectively corresponding to the two types of functions can be easily selected.

For example, in the case where the sub-pointer shaft 25 is attached to the first shaft attachment holes 29a and 33a, the third sub-display area 11a is formed into a substantially fan shape, and the sub-pointer shaft 25a in the sub-pointer wheel 25 is arranged in an area central to the substantially fan shape. As a result, a stop watch time can be indicated by the third sub-pointer 15 moving back and forth by a retrograde mechanism for each 1/20 second in the upper portion of the substantially fan-shaped third sub-display area 11a.

Also, in the case where the sub-pointer shaft 25 is also attached to the second shaft attachment holes 29b and 33b, the third sub-display area 12a is formed into a substantially circular shape, and the sub-pointer shaft 25a in the sub-pointer wheel 25 is arranged in a central portion of the circular shape. As a result, the remaining amount of the battery can be indicated by moving the third sub-pointer 15 in the upper portion of the substantially circular-shaped third sub-display area 12a.

### Second Embodiment

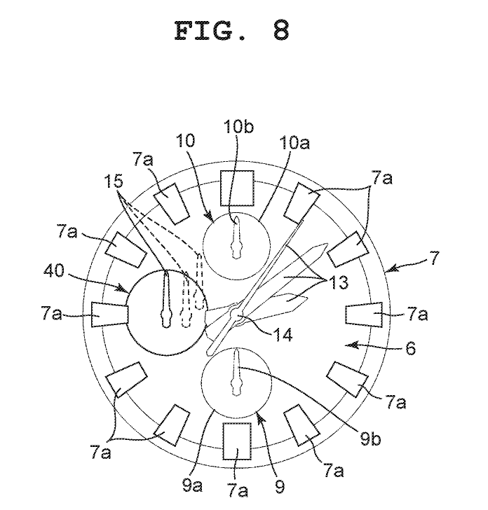

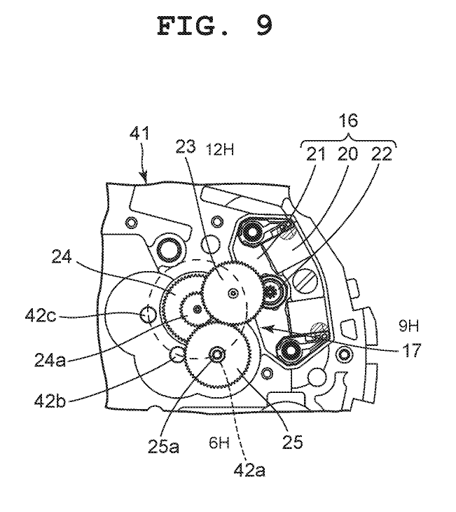

Next, a second embodiment is described with reference to FIG. 8 and FIG. 9. Sections that are the same as those of the first embodiment shown in FIG. 1 to FIG. 7 are provided with the same reference numerals.

This wristwatch has a structure similar to that of the first embodiment except that the installation position of the third sub-pointer 15 can be changed to be in any one of three different areas, as shown in FIG. 8 and FIG. 9.

That is, as shown in FIG. 9, a first supporting member 41 corresponding to a third sub-display section 40 is structured such that the stepping motor 16 and the wheel train section 17 are arranged, as with the first embodiment. Also, in this case, the wheel train section 17 includes the first intermediate wheel 23 which rotates as the rotor 22 in the stepping motor 16 rotates, the second intermediate wheel 24 which rotates as the first intermediate wheel 23 rotates, and the sub-pointer wheel 25 which rotates as the second intermediate wheel 24 rotates, and is structured such that the third sub-pointer 15 is attached to the sub-pointer shaft 25a in the sub-pointer wheel 25.

In this case, the first supporting member 41 is provided with three types of first to third shaft attachment holes 42a to 42c, as shown in FIG. 9. As a result, the sub-pointer wheel 25 is structured such that the sub-pointer shaft 25a is selectively attached to one of the first to third shaft attachment holes 42a to 42c. That is, the first to third shaft attachment holes 42a to 42c are provided on a circumference (a circumference indicated by a dotted line in FIG. 9) centered at a rotation center of the second intermediate wheel 24 which engages with the sub-pointer wheel 25.

Also, the stepping motor 16 and the wheel train section 17 are structured to be arranged with them being interposed between the first supporting member 41 and a second supporting member (not shown), as with the first embodiment. In this case, the second supporting member is also provided with three types of first to third shaft attachment holes (not shown) corresponding to the three types of first to third shaft attachment holes 42a to 42c provided in the first supporting member 41.

As a result, the third sub-display section 40 is structured such that three types of display forms, i.e., three types of display functions and three types of display shapes are acquired because the installation position of the sub-pointer shaft 25a in the sub-pointer wheel 25 is changed to be in one of three areas when the sub-pointer shaft 25a is selectively attached to one of the first to third shaft attachment holes 42a to 42c, as shown in FIG. 8.

In this wristwatch, the first to third shaft attachment holes 42a to 42c provided in a plurality of positions of the first supporting member 41 and first to third shaft attachment holes (not shown) provided in a plurality of positions of the second supporting member (not shown) respectively correspond to each other, and the sub-pointer wheel 25 in the wheel train section 17 can be selectively attached to one of the three sets of shaft attachment holes. As a result of this structure, the first and second supporting members 41 need not be replaced, and the installation position of the sub-pointer shaft 25a in the sub-pointer wheel 25 can be changed to be in one of the three areas, whereby the installation position of the third sub-pointer 15 can be easily changed, as with the first embodiment.

Also, in this wristwatch, the wheel train section 17 includes the first and second intermediate wheels 23 and 24 which transmit the rotation of the stepping motor 16 to the sub-pointer wheel 25, and the first to third shaft attachment holes 42a to 42c are provided on the circumference centered at the rotation center of the second intermediate wheel 24 which engages with the sub-shaft wheel 25. As a result, even when the sub-pointer shaft 25a in the sub-pointer wheel 25 is attached to one of the first to third shaft attachment holes 42a to 42c, the sub-pointer wheel 25 can be reliably and favorably rotated by the second intermediate wheel 24.

Moreover, in this wristwatch, by the sub-pointer shaft 25a in the sub-pointer wheel 25 being selectively attached to one of the first to third shaft attachment holes 42a to 42c, the installation position of the sub-pointer shaft 25a can be changed to be in one of the three areas. Accordingly, the third sub-display section 40 can be easily changed to be in one of the three types of display forms, or in other words, the third sub-display section 40 can be easily changed to have one of the three types of display functions and one of the three types of display shapes in accordance with the installation position of the sub-pointer shaft 25a.

In the above-described first and second embodiments, the installation position of the sub-pointer shaft 25 is changed to be in one of the two or three areas. However, the present invention is not limited thereto, and a structure may be adopted in which shaft attachment holes are provided in four or more areas on the circumference centered at the rotation center of the second intermediate wheel 24 which engages with the sub-pointer wheel 25, whereby the installation position of the sub-pointer wheel 25 can be changed to be in one of four or more areas.

Also, in the above-described first and second embodiments, the wheel train section 17 includes the first intermediate wheel 23 and the second intermediate wheel 24. However, the present invention is not limited thereto. For example, a structure may be adopted in which the wheel train section 17 includes only one intermediate wheel. In addition, a structure may be adopted in which the wheel train section 17 includes three or more intermediate wheels. In these structures, a plurality of shaft attachment holes are provided on the circumference centered at the rotation center of the intermediate wheel which engages with the sub-pointer wheel 25.

Moreover, in the above-described first and second embodiments, the present invention has been applied to the third sub-pointer 15 in each of the third sub-display sections 11, 12 and 40. However, the present invention is not limited thereto. For example, the present invention is also applicable to the first sub-pointer 9b in the first sub-display section 9 and the second sub-pointer 10b in the second sub-display section 10.

Furthermore, in the first and second embodiments and the modification examples described above, the present invention has been applied to a pointer-type wristwatch. However, the present invention is not necessarily required to be applied to a wristwatch. For example, the present invention is applicable to various types of pointer-type timepieces such as a travel watch, an alarm clock, a table clock, and a wall clock.

While the present invention has been described with reference to the preferred embodiments, it is intended that the invention be not limited by any of the details of the description therein but includes all the embodiments which fall within the scope of the appended claims.

What is claimed is:

1. A wheel train device comprising:
a dial plate having a display area provided between a central portion and an outer peripheral portion;
a wheel train section having a pointer wheel to which a pointer that moves above the display area is attached;
a supporting member which supports the wheel train section in an area corresponding to the display area; and
a plurality of shaft attachment holes which are provided in a plurality of positions of the supporting member and to which the pointer wheel is selectively attached in one of the plurality of positions.

2. The wheel train device according to claim 1, wherein the wheel train section includes one or a plurality of intermediate wheels which transmit rotation of a motor to the pointer wheel, and
wherein the plurality of shaft attachment holes are provided in a circumference centered at a rotation center of an intermediate wheel which engages with the pointer wheel among the one or plurality of intermediate wheels.

3. The wheel train device according to claim 1, wherein a main display area is provided in a central portion of the dial plate,
wherein the display area is a sub-display area, and
wherein the pointer is a sub-pointer which moves in the sub-display area.

4. The wheel train device according to claim 2, wherein a main display area is provided in a central portion of the dial plate,
wherein the display area is a sub-display area, and
wherein the pointer is a sub-pointer which moves in the sub-display area.

5. The wheel train device according to claim 3, wherein a display form of the sub-display area varies in accordance with an attachment position of the pointer wheel with respect to the plurality of shaft attachment holes.

6. The wheel train device according to claim 4, wherein a display form of the sub-display area varies in accordance with an attachment position of the pointer wheel with respect to the plurality of shaft attachment holes.

7. A timepiece comprising the wheel train device according to claim 1.
